(19) United States
(12) Patent Application Publication
(10) Pub. No.: US 2012/0307263 A1
(43) Pub. Date: Dec. 6, 2012

(54) NETWORK PRINTER AND PRINTING METHOD USING SAME

(75) Inventors: Takashi Ichikawa, Shizuoka-ken (JP); Kaoru Uematsu, Shizuoka-ken (JP); Takashi Goto, Shizuoka-ken (JP)

(73) Assignee: TOSHIBA TEC KABUSHIKI KAISHA, Tokyo (JP)

(21) Appl. No.: 13/473,779

(22) Filed: May 17, 2012

(30) Foreign Application Priority Data
May 31, 2011 (JP) 2011-121830

(51) Int. Cl. G06K 15/02; G06F 3/12

(52) U.S. Cl. 358/1.8; 358/1.13; 358/1.11

(57) ABSTRACT

A printing method, comprising: determining whether or not a printer is capable of executing a printing command sent from a user terminal to the printer through a first communication channel; requesting a cloud computer through a second communication channel to provide an information needed to execute the printing command if the printer is not capable of executing the printing command; and executing the printing command after the information needed to execute the printing command is downloaded to the printer from the cloud computer.

### CROSS-REFERENCE TO RELATED APPLICATION

This application is based upon and claims the benefit of priority from Japanese Patent Application No. 2011-121830, filed May 31, 2011, the entire contents of which are incorporated herein by reference.

### FIELD

Embodiments described herein relate to a network printer and a printing method using same.

### BACKGROUND

With the appearance of a demand for high-resolution and high-quality printing, a printer is necessary to have a more advanced function such as a more advanced image processing, printing processing and a power-saving function etc. In order to cope with these requirements, attempts are made to install application software for achieving advanced image processing and printing functions or to be equipped with various printing fonts in a printer. However, theses attempts have led to a more complicated printer structure as well as an increase in both power consumption and cost.

On the other hand, a printer that, if a printing font designated by a user equipment (peripheral equipment) is not provided in the printer, downloads the printing font from a host computer is well known.

### BRIEF DESCRIPTION OF THE DRAWINGS

FIG. 1 is a schematic diagram roughly showing the systemic components of a network printer according to an embodiment;

FIG. 2 is a diagram showing the flow of the rough output control of the printer shown in FIG. 1; and

FIG. 3 is a schematic diagram roughly showing the systemic components of a network printer according to other embodiment.

### DETAILED DESCRIPTION

According to one embodiment, a network printer, comprising: a first communication channel configured to communicate a first information with a user terminal; a second communication channel configured to communicate a second information with a cloud computer; an operation processor configured to analyze a printing command, that is from the user terminal, acquired through the first communication channel to detect the information required to execute the printing command; a download unit configured to request the cloud computer through the second communication channel to provide the information, which is needed for the execution of the printing command, detected by the operation processor and to download the information needed for the execution of the printing command from the cloud computer; a printing head configured to print, on a paper, a depiction data generated with the information needed for the execution of the printing command downloaded by the download unit; and a printing control unit configured to control the printing by the printing head on the paper.

According to other embodiment, a printing method, comprising: determining whether or not a printer is capable of executing a printing command sent from a user terminal to the printer through a first communication channel; requesting a cloud computer through a second communication channel to provide an information needed to execute the printing command if the printer is not capable of executing the printing command; and executing the printing command after the information needed to execute the printing command is downloaded to the printer from the cloud computer.

The network printer provided in an embodiment of the present invention is described in detail below with reference to accompanying drawings.

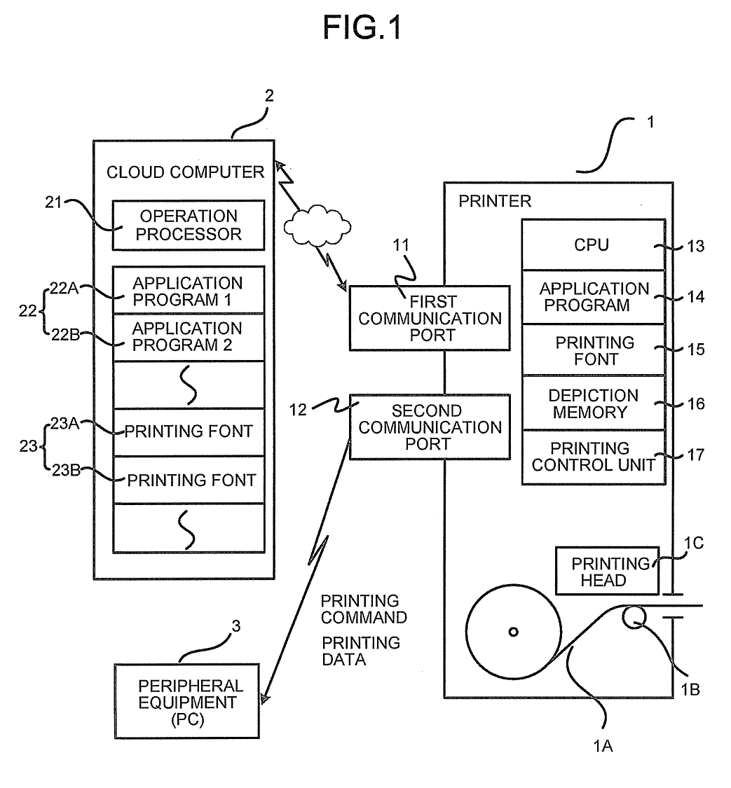

FIG. 1 is a schematic diagram roughly showing the systemic components of a network printer according to an embodiment, in FIG. 1, a reference numeral 1 denotes a network printer (hereinafter referred to as a printer), and a reference numeral 2 denotes a cloud computer. The printer 1 is basically a simple printer which only has minimum and essential printing functions. The cloud computer 2 is a computer capable of coping with the various proposed high definition technologies and high image quality technologies with advanced processing function, specifically, the cloud computer 2 is a high-performance and high-speed processing computer which is equipped with various printing fonts and achieves a high-detailed depiction processing function and a printing control function, using a so-called cloud computing function. Further, the cloud computer 2 also has a function of calculating the various operation control parameters for running the printer 1 in the optimal condition by providing the output information of sensors that indicates the operation state of the printer 1.

The printer 1, for example, which is a thermal printer of heat-transfer type using an ink ribbon, includes a hardware mechanism such as a platen roller 1b and so on which feeds the leading edge of a rolled paper 1a to supply it to be printed, and a printing head (thermal head) 1c which prints characters on the paper 1a using the ink ribbon. Further, although a thermal printer is illustrated here as an example, other types of printers are also applicable.

On the other hand, a user terminal 3, which may be, for example, a common office computer or personal computer, uses the network printer 1 to print documents, etc. Such a user terminal 3 outputs a printing command and printing data to the printer 1 through a given communication channel to activate the printer 1.

The printer 1 comprises two independent communication channels: a first communication channel 11 and a second communication channel 12.

The first communication channel 11 performs the role of transmitting information with the cloud computer 2 for the printer 1, to download the information that the printer 1 needs, and the information specifically refers to printing application software, printing fonts and printing control parameters (for example, set value for controlling) (a download unit). The second communication channel 12 performs the role of transmitting information that is a general printing command or a printing data with the user terminal 3.

The printer 1 comprises a CPU 13 for implementing an over all control, a ROM 14 for storing the basic application software needed to execute a printing processing, a ROM 15 for storing fonts, a depiction memory (image memory) 16 for developing document data, and a printing control unit 17 for controlling the operations of the hardware mechanisms.

On the other hand, the cloud computer 2 is internally provided with an operation processor unit 21 having the above-mentioned advanced processing function, a various kinds of printing softwares 22 (22a, 22b, . . . ) capable of executing a variety of forms of printing, and a variety of printing fonts 23 (23a, 23b, . . . ). As stated below, the printing softwares 22 (22a, 22b, . . . ) and the printing fonts 23 (23a, 23b, . . . ) are selectively downloaded according to the request of the printer 1.

The printing softwares 22 (22a, 22b, . . . ) include a program for various image processing, a program for controlling a thermal heating, an analyzing program of the application software used in a third-party printer and a software program for emulating the processing program.

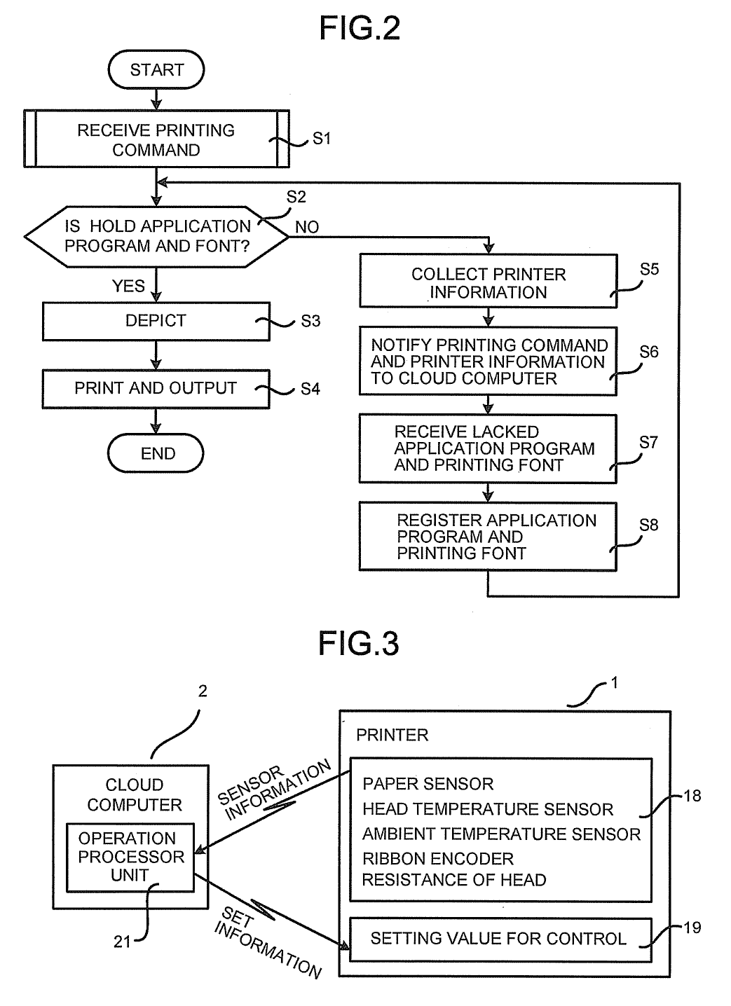

FIG. 2 is a flow chart showing the sequence of the primary operations of the printer 1. The CPU 13 of the printer 1 starts the operation after receiving the printing command output from the user terminal 3 through the second communication channel 12 (Act S1). The CPU 13 first determines whether or not the printing command received by the printer 1 is supported (Act S2). That is, the CPU 13 determines whether or not there is a printing software and a printing font installed in the printer 1 which support the printing of data according to the font and quality specified by the printing command. The determination is carried out, for example, by detecting whether or not the format information contained in the received printing command is pre-registered in the printer 1.

In such a manner, in the case where a printing software and a printing font which are capable of achieving the printing quality specified by the printing command are stored in the printer 1 beforehand, in other words, if the printer 1 is supportive to the printing command by an application software 14 and printing font 15 basically installed therein, the application software 14 and the printing font 15 are used to develop the printing data provided by the user terminal 3 on the depiction memory 16 (Act S3). Then, the hardware mechanisms operate under the control of the printing control unit 17 to print the data depicted on the depiction memory 16 on a paper 1a and output the printed paper 1a (Act S4).

If the application software 14 and printing font 15 installed in the printer 1 are unsupportive to the printing command, the CPU 13 of the printer 1 collects printer information containing the information of the lacked or required application software 14 and printing font 15 (Act S5).

The collected printer information and the printing command received from the user terminal 3 are together notified to the cloud computer 2 through the first communication channel 11 to request supply of lacked software and font (Act S6) Sequentially, the cloud computer 2 analyzes the printing command and the printer information in the above-described operation processor unit 21, and retrieves and detects the application software 22 and printing font 23 needed to execute the printing command received by the printer 1. The CPU 13 of the printer 1 receives the application software 22 and printing font 23 detected in this manner from the cloud computer 2 through the first communication channel 11 (Act S7).

The printer 1 downloads the application software 22 and printing font 23 lacked or required to execute the printing command from the cloud computer 2 and stores the download application software 22 and printing font 23 in an internal memory (not shown) (Act S8).

After downloading the application software 22 and printing font 23 capable of executing the printing command from the cloud computer 2 in this way, the printer 1 again carries out the above-described determination processing of the printing command (Act S2). At this time, since the application software 22 and printing font 23 supportive to the printing command are already downloaded, the software 22 and font 23 can be used to develop the printing data provided by the user terminal 3 on the depiction memory 15 (Act S3), and the hardware mechanisms are activated under the control of the printing control unit 17 to print the printing data on the paper 1a (Act S4).

In accordance with the network printer having the above-described structure, even the main body of the printer 1 is so simply structured as to provide merely the basic functions, the printer 1 downloads the proper information (software and/or font) needed for the execution of a printing command from the cloud computer 2, and can therefore be fully supportive to the various printing commands provided by the user terminal 3. Moreover, the printer 1 may only determine whether or not the provided printing command is supported and, if it cannot execute the printing command due to the lack of appropriate software and font, only the application software 22 and printing font 23 needed to execute the printing command are downloaded from the cloud computer 2.

Even the printer 1 is not all equipped with various kinds of application softwares 22 (22a, 22b, . . . ) and various kinds of printing fonts 23 (23a, 23b, . . . ), the printer 1 may download from the cloud computer 2 appropriate application software and printing fonts supportive to the printing command provided by the user terminal 3. Therefore, no complexity is led to the structure of the printer 1, and no increase in cost is added to the printer 1.

By downloading software and/or font needed to execute the printing command from the cloud computer 2 through the Internet, the printer 1 may flexibly utilize the cloud computer 2 having a high-performance much outperforming the basic printing control functions of the printer 1 to develop printing data with the quality and font specified by the printing command and to output the printing data. Therefore, different from a conventional server printer that has both a server computer and a printer, the printer 1 is out of the direct control of the server computer and may utilize the advanced printing function of a cloud computer at any place at any time.

The information communication between the printer 1 and the cloud computer 2 is carried out through the first communication channel 11 independent from the user terminal 3. Therefore, the user terminal 3 may output a printing command and printing data to the printer 1 only through the second communication channel 12 of the printer 1. As a result, the user terminal 3 may obtain the printed document of a desired quality only by outputting a printing command, regardless of the processing capability of the main body of the printer 1. Thus, the processing load by the user terminal 3 can be reduced and the operability of the user terminal 3 can also be improved.

FIG. 3 is a diagram showing another embodiment. In this embodiment, the advanced analysis processing function, especially the function of managing the operation of the printer 1, of the cloud computer 2 may be utilized flexibly to optimize the operations of the printer 1.

As the concept described above is shown in the schematic diagram of FIG. 3, the output information of the various sensors 18 assembled in the printer 1 is notified to the cloud computer 2 when the printer 1 requests the cloud computer 2 to provide the information needed to execute a printing command. The sensor information represents the operation environment of the printer 1 and the states of the hardware mechanisms, for instance, in the case of a thermal printer, the sensor information includes information representing presence or absence (the end) of the paper 1a detected by a paper sensor, temperature information of a thermal head detected by a head temperature sensor, ambient temperature information around the printer detected by an environment temperature sensor, ink ribbon information detected by a ribbon encoder and resistance information of the thermal head.

The cloud computer 2 analyzes the sensor information using the operation processor unit 21 thereof to calculate conditions for optimizing operations of the printer 1. For example, in the case of a thermal printer, the conditions for optimizing the operations of the printer 1, for example, how much amount to which the heating temperature of a thermal head is set so as to achieve a high-quality printing, or how to drive the thermal head so as to achieve the set heating temperature, are analyzed according to the type of the paper 1a and the ambient temperature.

The analyzed optimal operation conditions are downloaded to the printer 1 as a set value for controlling 19.

For example, a threshold should be set for the boundary between a label and a clearance in the case where labels are successively printed. In this case, the output waveform detected by a paper sensor is sent from the printer 1 to the cloud computer 2 to enable the cloud computer 2 to grasp comprehensively the output waveforms of the paper sensor over the plurality of papers during the convey of the paper (labels). As a result, the cloud computer 2 can determine an optimal threshold and sends the optimal threshold to the printer 1, thus, the printer 1 may set the optimal threshold without carrying out a complicated optimization processing.

By sending the temperature of a thermal head during printing from the printer 1 to the cloud computer 2 as a sensor output information, the temperature changes of the thermal head may be observed sequentially in the cloud computer 2, therefore, an optimal control is realized herein, compared with the thermal energy control which is conventionally determined according to the instantaneous temperature change in the printer 1. That is, the thermal printer prints through the thermo-sensitive coloring of a thermal paper coated with a heat-sensitive paint or through the heat-transfer of an ink ribbon to a paper. In order to achieve the optimal printing quality, an optimal heat amount applied to a paper or an ink ribbon should be specified. In addition to this, increase in heat accumulation of the thermal head and increase in ambient temperature generated in the repeated printing, influence in heat from neighboring heat generating elements, and a thermal hysteresis of the thermal head should also be taken into consideration so as to carry out an appropriate printing control. Such a control is generally carried out by a control logic block mounted in a printer, conventionally. In this embodiment, however, parameters of such as a paper, an ink ribbon, a printing speed and the number of printing papers and output of sensors are sent from the printer 1 to the cloud computer 2 along with a printing command information, and the cloud computer 2 evaluates the thermal hysteresis of a thermal head composed of heat generating elements according to the received information and a printing image, then, calculates the actual heat applying data and actual heat applying time of the thermal head and sends the calculated results (data and time) to the printer 1. The printer 1 achieves the optimal printing based on the received actual heat applying data and time.

In this way, according to the printing system in which the cloud computer 2 exclusively executes a determination processing of an optimum operation condition of the printer 1, and the calculated optimum operation condition is downloaded to the printer 1 as set control values 19, the user of the printing system is free from setting of an operation condition for printer 1 based on her or his usage experiences. Furthermore, there is also no need to install an optimization setting program of an operation conditions with complicated and sophisticated analysis processing, and thus, increase in information processing capability (processing speed, processing capacity, etc.) of the printer 1 more than a necessity is not required. Thus, the printer 1 (printer main body) may be significantly simplified while keeping high printing capability (high printing quality) enough to realize a high level printing. Moreover, the processing capability of the cloud computer 2 may be fully utilized to set optimal operation conditions with an excellent response according to the environment in which the operations are carried out.

As stated above, in accordance with this embodiment, it can provide a network printer which be able to effectively deal with a high-quality and high-resolution printing without complicating the structure of the printer and increasing the cost.

The present invention is not limited to the embodiment above. Although the embodiment above is described by taking a thermal printer as an example, the present invention is certainly applicable to other printers such as an inkjet printer or laser printer which print in other manners. Moreover, the cloud computer 2 may manage a plurality of printers 1. Further, there is no limitation to the printing code analysis algorithm of the cloud computer 2, and the printing application program may include the so called emulation software of which a printing command and the format of the printing command are different from the above.

In the embodiment above, the application software or printing front lacked in the printer is downloaded from the cloud computer, however, an alternative approach may be adopted in which the depiction data of the same application software or printing front may be generated by the cloud computer and then sent to the printer. The printer may store the received depiction data in a depiction data memory and read the data to carry out a printing.

The optimizing setting of the operation conditions for the printer 1 is not surely carried out in union with the download of the application software and/or printing font. Besides, the above-described optimizing setting is applicable to not only the printing-output of character data but also the depicting-output of graphics based on CAD data. In addition, various modifications may be devised without departing from the scope of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A network printer, comprising:
a first communication channel configured to communicate a first information with a user terminal;
a second communication channel configured to communicate a second information with a cloud computer;
an operation processor configured to analyze a printing command, that is from the user terminal, acquired through the first communication channel to detect the information required to execute the printing command;
a download unit configured to request the cloud computer through the second communication channel to provide the information, which is needed for the execution of the printing command, detected by the operation processor and to download the information needed for the execution of the printing command from the cloud computer;
a printing head configured to print, on a paper, a depiction data generated with the information needed for the execution of the printing command downloaded by the download unit; and
a printing control unit configured to control the printing by the printing head on the paper.

2. The network printer according to claim 1, wherein
the information needed for the execution of the printing command includes a second application software with which the printer is not equipped, the result data processed by the second application software or a printing font.

3. The network printer according to claim 2, wherein
the application software used in the printer includes a setting value for control acquired through an operation processing that is carried out by the cloud computer based on the output data of a various sensors of the printer.

4. A printing method, comprising:
determining whether or not a printer is capable of executing a printing command sent from a user terminal to the printer through a first communication channel;
requesting a cloud computer through a second communication channel to provide an information needed to execute the printing command if the printer is not capable of executing the printing command; and
executing the printing command after the information needed to execute the printing command is downloaded to the printer from the cloud computer.

5. The printing method according to claim 4, wherein
the information needed to execute the printing command includes an application software with which the printer is not equipped, a result data processed by the application software or a printing font.

6. The printing method according to claim 5, wherein
the information needed to execute the printing command includes a setting value for control acquired through an operation processing that is carried out by the cloud computer based on the output data of the various sensors of the printer.
